(19) United States
(12) Patent Application Publication
(10) Pub. No.: US 2011/0173416 A1
(43) Pub. Date: Jul. 14, 2011

(54) DATA PROCESSING DEVICE AND PARALLEL PROCESSING UNIT

(75) Inventors: Hideyuki NODA, Kanagawa (JP); Takeaki Sugimura, Kanagawa (JP)

(73) Assignee: RENESAS ELECTRONICS CORPORATION

(21) Appl. No.: 12/984,978

(22) Filed: Jan. 5, 2011

(30) Foreign Application Priority Data
Jan. 8, 2010 (JP) 2010-003075

(51) Int. Cl. G06F 15/76; G06F 9/02

(52) U.S. Cl. 712/29; 712/E09.002

(57) ABSTRACT

A data processing device in which parallel processing elements can efficiently perform processing is provided. A parallel processing module includes plural processing elements, banks A and B provided to correspond to the processing elements and used to store data to be used when the processing elements perform processing, and an I/O bank provided to correspond to the processing elements and used to transfer data to and from an external memory. A first selector circuit selectively couples bank B or the I/O bank to the processing elements. A second selector circuit selectively couples the external memory or the processing elements to the I/O bank. Thus, data can be transferred from the external memory to the I/O bank concurrently with the processing performed by the processing elements. The processing elements can therefore perform processing efficiently.

### CROSS-REFERENCE TO RELATED APPLICATIONS

The disclosure of Japanese Patent Application No. 2010-3075 filed on Jan. 8, 2010 including the specification, drawings and abstract is incorporated herein by reference in its entirety.

### BACKGROUND OF THE INVENTION

The present invention relates to a technique for executing a signal processing application at high speed and, more particularly, to a data processing device and a parallel processing unit for processing a large volume of data at high speed by a single instruction multiple data stream (SIMD) method.

In recent years with digital consumer products increasingly widespread, the importance of digital signal processing for processing a large volume of data, for example, audio and video data, at high speed has been increasing. For such digital signal processing, digital signal processors (DSPs) are generally used as specialized semiconductor devices. For signal processing applications, particularly, image processing applications, however, the volume of data to be processed is so large that the processing capacity of DSPs is not large enough.

Under such circumstances, the development of parallel processor technology for realizing high signal processing performance by concurrently operating plural processing elements is being promoted. When such a specialized processor is used as an accelerator provided for a central processing unit (CPU), it can realize, like an LSI mounted in a built-in device, high signal processing performance even in cases where low power consumption and a low cost are requirements. Among relevant technologies in this regard are those disclosed in Japanese Unexamined Patent Publication Nos. 2002-358288 and Hei 11 (1999)-312085.

Japanese Unexamined Patent Publication No. 2002-358288 is aimed at providing a semiconductor integrated circuit for efficiently performing SIMD processing. The semiconductor integrated circuit includes an SIMD processing section which can concurrently process plural pieces of data, a data buffer which can be coupled to the SIMD processing section, and a data transfer control section for controlling data transfer to and from the data buffer. The data transfer control section can control, while plural pieces of data read from the data buffer are processed by the SIMD processing section, data transfer to have data to be processed next transferred to the data buffer. Since, concurrently with the processing performed by the SIMD processing section, data required for subsequent processing is transferred to the data buffer, the SIMD processing section can continue processing without being interrupted by internal operation for transferring data to be processed to the data buffer. This enables efficient SIMD processing.

Japanese Unexamined Patent Publication No. Hei 11 (1999)-312085 is aimed at solving a problem in which, when an external memory is frequently accessed taking a relatively long period of time, the time spent in accessing the external memory prevents SIMD processing from being adequately efficient. To solve the problem, two internal memories are provided between an SIMD processing section and the external memory. While processing is performed with one of the two internal memories connected, by an instruction control unit, to the SIMD processing section, the other internal memory is connected to the external memory via a data transfer control unit and is made to read packed data required for subsequent processing from the external memory or write packed data obtained as a result of processing performed by the SIMD processing section to the external memory.

### SUMMARY OF THE INVENTION

In cases where image processing is performed using a specialized processor, for example, an SIMD type parallel processor which makes plural processing elements operate concurrently, the processing elements (PEs) included in the parallel processor perform processing, as described later, accessing a data buffer coupled to the PEs. Hence, a system is required which is arranged to enable efficient data transfer from an external memory to the data buffer and allow the PEs to access the data buffer efficiently.

In cases where an extracted portion of two dimensional image data is processed, a system is required which enables the extracted image data to be efficiently aligned in the data buffer coupled to the PEs.

The present invention has been made in view of the above requirements and it is an object of the invention to provide a data processing device and a parallel processing unit which enable parallel processing elements to perform processing efficiently.

According to an embodiment of the present invention, a data processing device including a CPU and a parallel processing module coupled to each other via a system bus is provided. The parallel processing module performs processing according to a request from the CPU. The parallel processing module includes plural parallel processing elements, banks A and B provided to correspond to the parallel processing elements and used to store data to be used when the parallel processing elements perform processing, an I/O bank provided to correspond to the parallel processing elements and used to transfer data to and from an external memory, a first selector circuit which selectively couples bank B or the I/O bank to the parallel processing elements, and a second selector circuit which selectively couples the external memory or the parallel processing elements to the I/O bank.

According to the embodiment, the second selector circuit selectively couples the external memory or the parallel processing elements to the I/O bank, so that data can be transferred from the external memory to the I/O bank concurrently with the processing performed by the parallel processing elements. This allows the parallel processing elements to efficiently perform processing.

### BRIEF DESCRIPTION OF THE DRAWINGS

FIG. 1 is a block diagram of a data processing device using an SIMD type parallel processing module.

FIG. 2 is a diagram showing an example of general image processing performed using the data processing device shown in FIG. 1.

FIG. 3 schematically shows example data flows during image processing performed by the data processing device shown in FIG. 1.

FIG. 4 shows an example address arrangement in data buffers 114 and 115 included in the parallel processing module 100.

FIG. 5 is a diagram for describing the manner in which PEs 113 and the data buffers 114 and 115 perform parallel processing in the parallel processing module 100 in accordance with control signals received from an operation control circuit 112.

FIG. 6 is a diagram showing an example configuration of a parallel processing module included in the data processing device according to an embodiment of the present invention.

FIG. 7 is a diagram for describing the manner in which data processing and data input/output operations are concurrently performed in the parallel processing module shown in FIG. 6.

FIG. 8 is a diagram for describing data copying between banks.

FIG. 9 is a diagram for describing an operating sequence, including parallel processing described with reference to FIG. 7 and data copying between banks described with reference to FIG. 8, of the parallel processing module according to the embodiment of the invention.

FIG. 10 is a diagram for describing the processing time used to process a one-line portion of image data using the data processing device according to the embodiment of the invention.

FIG. 11 is a diagram for describing the re-arrangement of region-of-interest (ROI) data performed by data copying between banks.

FIG. 12 is a diagram showing an example of ROI data processing performed by the data processing device shown in FIG. 1.

FIGS. 13(a) to 13(c) show different manners in which image data at a feature point and peripheral region thereof is extracted and stored in the data buffer 114 or 115.

FIG. 14 is a diagram for describing data alignment resulting from data copying between banks.

FIG. 15 is a diagram for describing efficient data alignment which can be achieved by data copying between banks.

FIG. 16 is a diagram showing an example configuration of the parallel processing module of a data processing device according to a modification of the embodiment of the present invention.

FIG. 17 shows an example system including the data processing device of the present invention.

### DETAILED DESCRIPTION OF THE PREFERRED EMBODIMENT

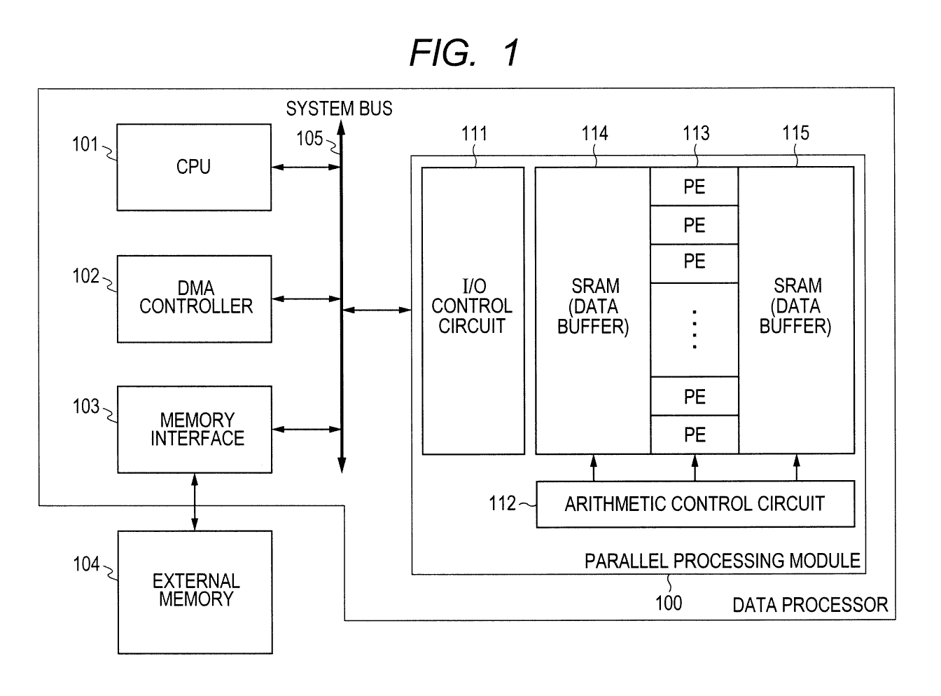

FIG. 1 is a block diagram of a data processing device using an SIMD type parallel processing module. The data processing device includes a parallel processing module 100, a CPU 101, a direct memory access (DMA) controller 102, a memory interface 103, and an external memory 104 which are interconnected via a system bus 105.

The external memory 104 stores programs to be executed by the CPU 101 and data to be referred to when programs are executed. The external memory 104 also stores data, for example, image data to be processed by the parallel processing module 100. Even though, in FIG. 1, the external memory 104 is illustrated as an externally coupled memory, it may be incorporated in the data processing device.

The memory interface 103 controls, responding to access requests from the CPU 101 and DMA controller 102, instruction code fetching from the external memory 104 and data reading from and writing to the external memory 104.

The CPU 101 controls the whole data processing device by fetching instruction codes from an internal memory, not shown, or from the external memory 104 via the memory interface 103 and executing the fetched instruction codes.

The DMA controller 102 controls DMA transfers in the data processing device in response to DMA transfer requests from the CPU 101. For example, the DMA controller 102 executes DMA transfers between the external memory 104 and an SRAM (hereinafter referred to as a “data buffer”) 114 or 115 included in the parallel processing module 100.

The parallel processing module 100 includes an I/O control circuit 111, an operation control circuit 112, PEs 113 corresponding to the number of entries, being described later, and the data buffers 114 and 115 corresponding to the PEs 113.

The data buffers 114 and 115 temporarily store data, for example, image data to be processed by the PEs 113 as an array of sampled data. The PEs 113 respectively process the arrayed data elements stored in the data buffers 114 and 115, thereby realizing parallel processing. The PEs 113 are provided to correspond to the number of entries allowing their performance to be optimized according to the required degree of parallelism. The following description is based on the assumption that the PEs 113 perform processing by the SIMD method and that they operate in the same manner. The operations of the PEs 113 and data buffers 114 and 115 will be described in detail later.

The I/O control circuit 111 controls, via the system bus 105, data input and output. When a request for signal processing is received via the system bus 105, the I/O control circuit 111 outputs the request for signal processing to the operation control circuit 112. When the result of signal processing is received under the control of the operation control circuit 112, the I/O control circuit 111 outputs the result of signal processing via the system bus 105.

When the request for signal processing is received from the I/O control circuit 111, the operation control circuit 112, while outputting control signals to the PEs 113 and data buffers 114 and 115 according to microcodes stored in an internal instruction memory, not shown, makes the PEs 113 sequentially perform required signal processing. The operation control circuit 112 subsequently makes the I/O control circuit 111 output the results of signal processing stored in the data buffers 114 and 115.

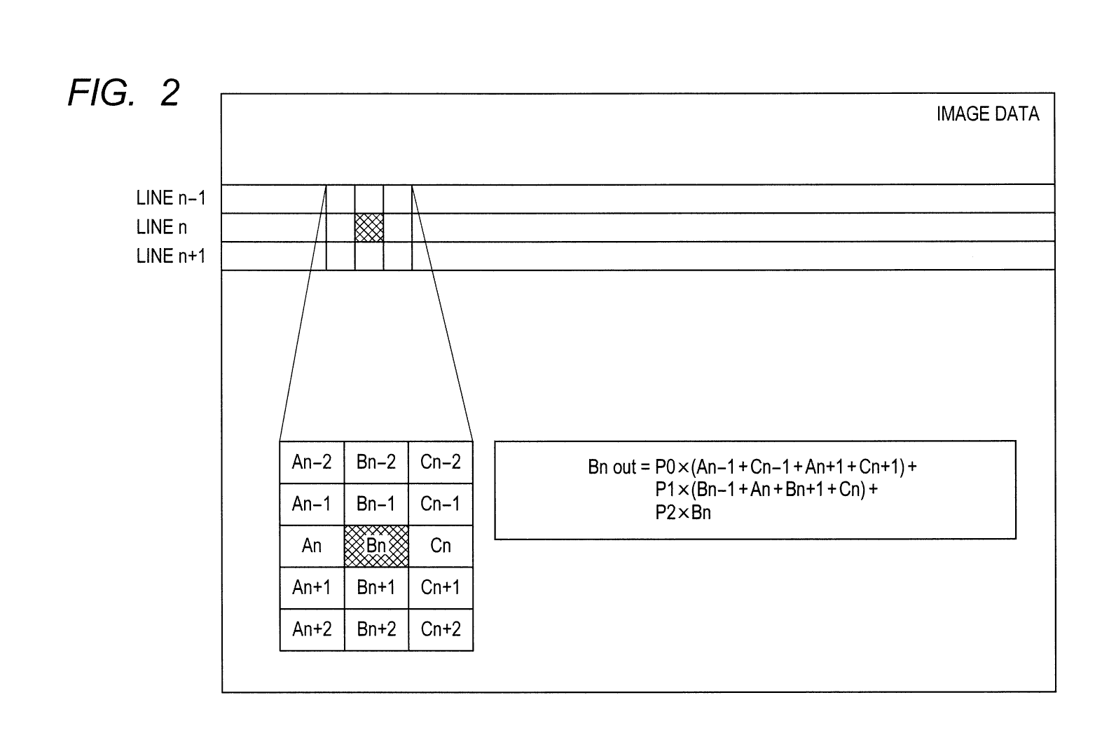

FIG. 2 is a diagram showing an example of general image processing performed using the data processing device shown in FIG. 1. The example processing shown in FIG. 2 represents a filtering process in which all pixels of an input image concurrently undergo the same local processing. Such a filtering process is performed, for example, for etching image edges or for blurring an image.

Referring to FIG. 2, pixel Bn undergoes filtering based on pixel values of the pixels surrounding the pixel Bn. Namely, the pixel value, Bn out, after filtering is determined as follows: the pixel values of pixels An−1, Cn−1, An+1, and Cn+1 are added up and the sum is multiplied by coefficient P0; the pixel values of pixels Bn−1, An, Bn+1, and Cn are added up and the sum is multiplied by coefficient P1; the pixel value of pixel Bn is multiplied by coefficient P2; and the products thus obtained are added up.

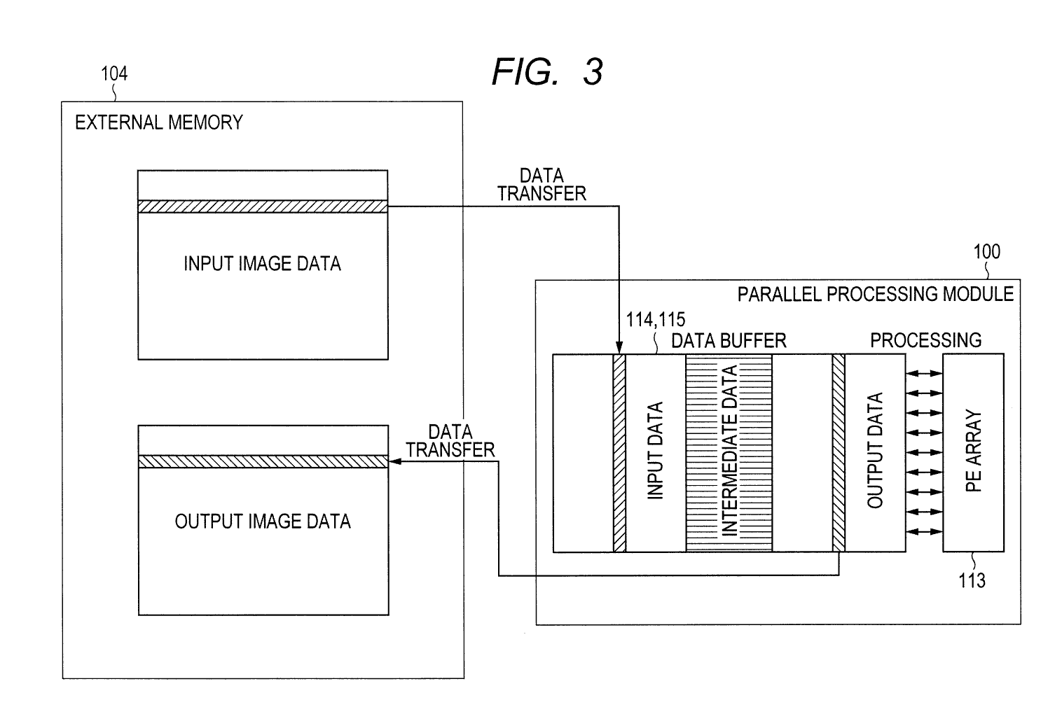

FIG. 3 schematically shows example data flows during image processing performed by the data processing device shown in FIG. 1. In the image processing shown in FIG. 3, the input image data stored in the external memory 104 is DMA-transferred column by column to the data buffer 114 or 115 included in the parallel processing module 100.

The data buffers 114 and 115 each include an input data area, an intermediate data area, and an output data area. The PEs 113 concurrently process the column-by-column image data stored in the input data area. When, during image data processing, it is necessary to store intermediate data, the PEs 113 store intermediate data in the intermediate data area of the data buffer 114 or 115. The data obtained as a result of processing is stored in the output data area of the data buffer 114 or 115 to be DMA-transferred as output image data to the external memory 104.

When, as shown in FIG. 3, DMA-transferring image data between the external memory 104 and the data buffer 114 or 115 or processing image data in the parallel processing module 100, it is necessary to specify relevant addresses in the data buffer 114 or 115 included in the parallel processing module 100.

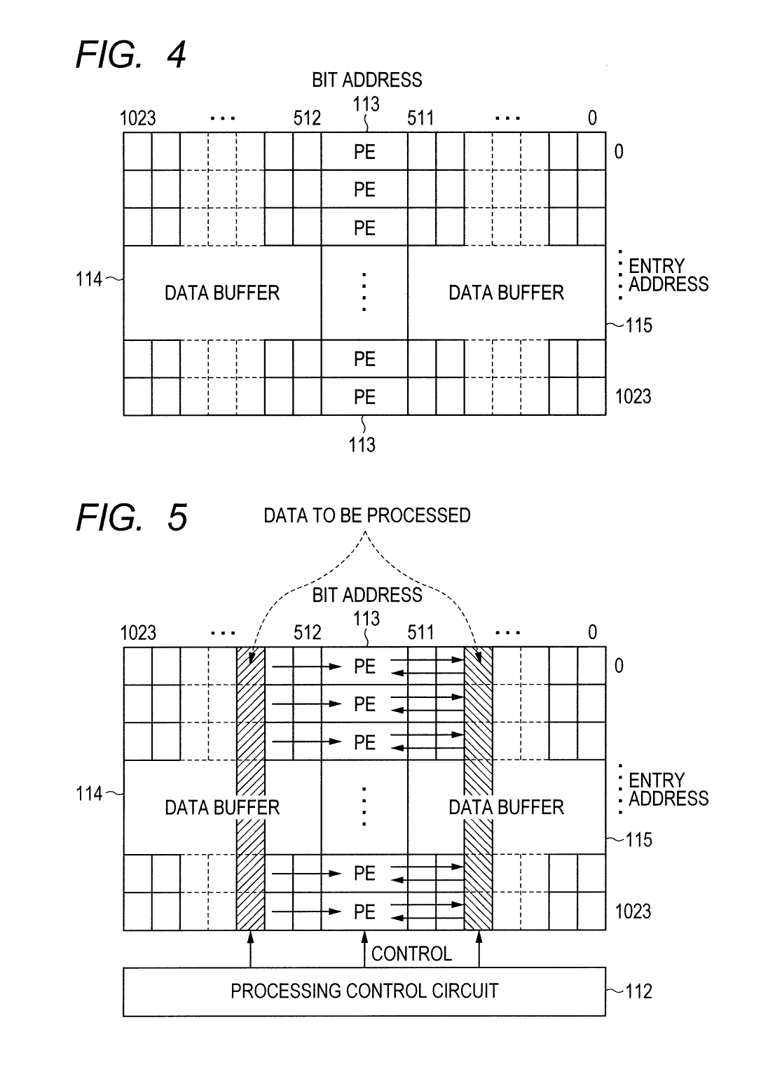

FIG. 4 shows an example address arrangement in the data buffers 114 and 115 included in the parallel processing module 100. Each PE 113 is coupled, on its left side, with a 512-bit portion (bit addresses 512 to 1023) of the data buffer 114 and, on its right side, with a 512-bit portion (bit addresses 0 to 511) of the data buffer 115. Each set of PE and a 1024-bit portion (512-bit portion+512-bit portion) of the data buffers is referred to as an entry. Namely, FIG. 4 shows an address space of 1024 entries (entry addresses 0 to 1023).

When DMA-transferring or processing data stored in the data buffer 114 or 115, the target data can be specified by bit address and entry address combinations.

FIG. 5 is a diagram for describing the manner in which the PEs 113 and the data buffers 114 and 115 perform parallel processing in the parallel processing module 100 in accordance with control signals received from the operation control circuit 112. The PEs 113 perform processing using the data stored at specified bit addresses, hatched in FIG. 5, of the data buffers 114 and 115, and store the result of processing at the specified bit addresses, hatched in FIG. 5, of the data buffer 115. Since, at this time, all entries simultaneously operate in SIMD mode, it is not necessary to specify entry addresses.

Regarding the above image processing technique making use of parallel processing elements, the data processing device according to an embodiment of the present invention will be described in detail below.

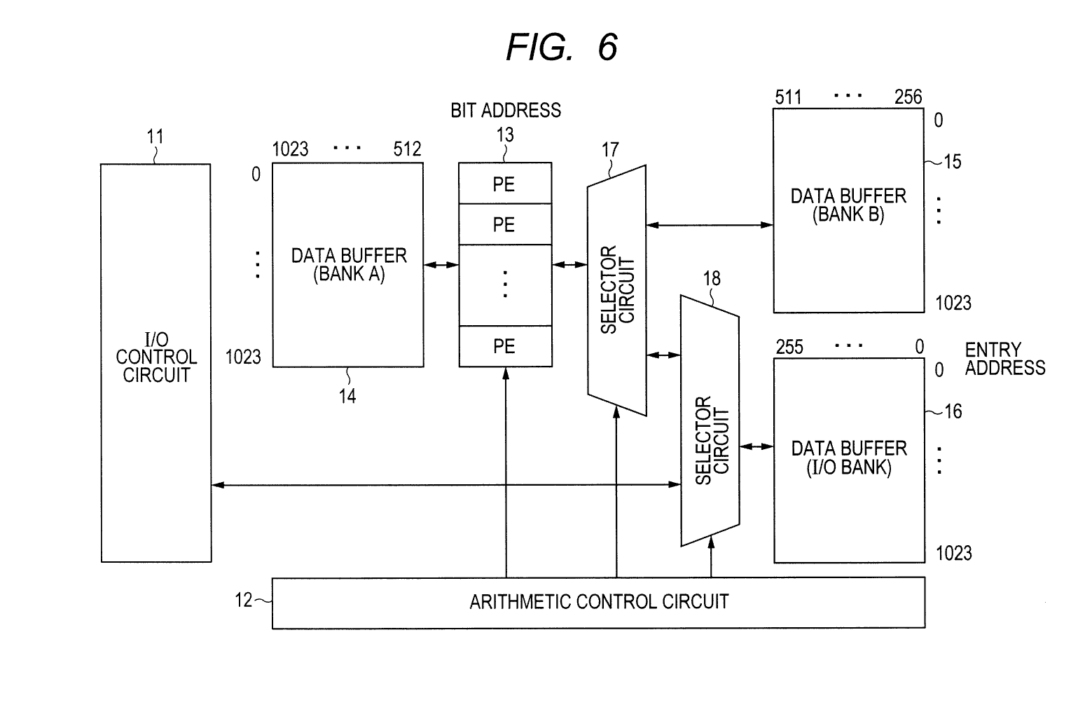

FIG. 6 is a diagram showing an example configuration of a parallel processing module included in the data processing device according to an embodiment of the present invention. The parallel processing module includes an I/O control circuit 11, an operation control circuit 12, PEs 13 corresponding to the number of entries, data buffers 14 to 16, and selector circuits 17 and 18. The overall configuration of the data processing device is similar to the data processing device configuration shown in FIG. 1.

The data buffers 14 to 16 are each arranged as an independent bank. The data buffer 14 is allocated bit addresses 512 to 1023 and is referred to as bank A (first bank). The data buffer 15 is allocated bit addresses 256 to 511 and is referred to as bank B (second bank). The data buffer 16 is allocated bit addresses 0 to 255 and is referred to as an I/O bank (third bank).

Comparing the data processing device configurations shown in FIGS. 1 and 6, the data buffer 114 shown in FIG. 1 is equivalent to bank A 14 shown in FIG. 6, and the data buffer 115 shown in FIG. 1 is equivalent to bank B 15 and I/O bank 16 shown in FIG. 6.

The PEs 13 realize parallel processing with each of them concurrently operating to process image data stored in the data buffers 14 to 16. The PEs 113 are provided to correspond to the number of entries allowing their performance to be optimized according to the required degree of parallelism.

The I/O control circuit 11 controls, via the system bus 105, data input and output. When a request for signal processing is received via the system bus 105, the I/O control circuit 11 outputs the request for signal processing to the operation control circuit 12. When the result of signal processing is received under the control of the operation control circuit 12, the I/O control circuit 11 outputs the result of signal processing via the system bus 105.

When a request for signal processing is received from the I/O control circuit 11, the operation control circuit 12 outputs control signals corresponding to microcodes stored in an internal instruction memory, not shown, to the PEs 13, data buffers 14 to 16, and selector circuits 17 and 18, making the PEs 13 perform processing sequentially as required to meet the request for signal processing. At this time, the operation control circuit 12 also controls data input and output.

The selector circuit 17 (first selector unit) can change the data path according to a control signal outputted from the operation control circuit 12. When the selector circuit 17 selects its coupling with bank B 15, the PEs 13 can make reference to the data stored in bank B 15 or can store data obtained as a result of processing in bank B 15. When the selector circuit 17 selects its coupling, via the selector circuit 18, with the I/O bank 16, the PEs 13 can make reference to the data stored in the I/O bank 16 or store data obtained as a result of processing in the I/O bank 16.

The selector circuit 18 (second selector unit) can change the data path according to a control signal outputted from the operation control circuit 12. When the selector circuit 18 selects its coupling with the I/O control circuit 11, data transfer between the external memory 104 and the I/O bank 16 via the I/O control circuit 11 is enabled. When the selector circuit 18 selects its coupling, via the selector circuit 17, with the PEs 13, the PEs 13 can make reference to the data stored in the I/O bank 16 or store data obtained as a result of processing in the I/O bank 16.

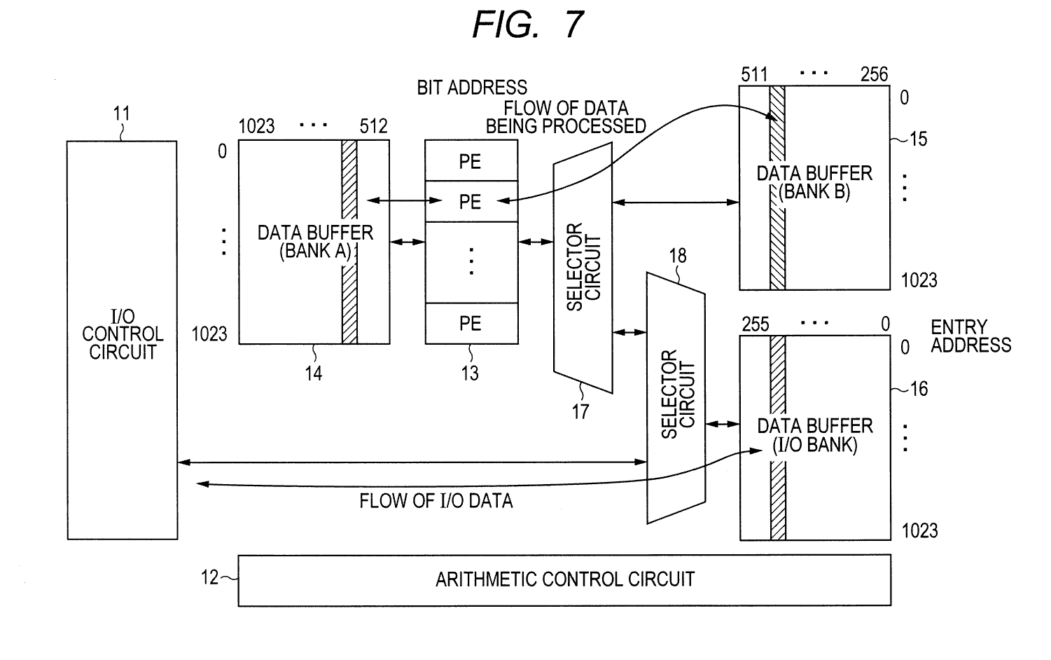

FIG. 7 is a diagram for describing the manner in which data processing and data input/output operations are concurrently performed in the parallel processing module shown in FIG. 6. Referring to FIG. 7, the selector circuit 17 is coupled to bank B 15; and the PEs 13 read data from bank A 14 and bank B 15, process the data, and write the results of processing in bank A 14 or bank B 15.

Also referring to FIG. 7, the selector circuit 18 is coupled to the I/O control circuit 11 allowing data input/output operation to be performed between the external memory 104 and the I/O bank 16 via the I/O control circuit 11. Thus, data transfer using the I/O bank 16 can be performed concurrently with the processing performed using bank A 14 and bank B 15.

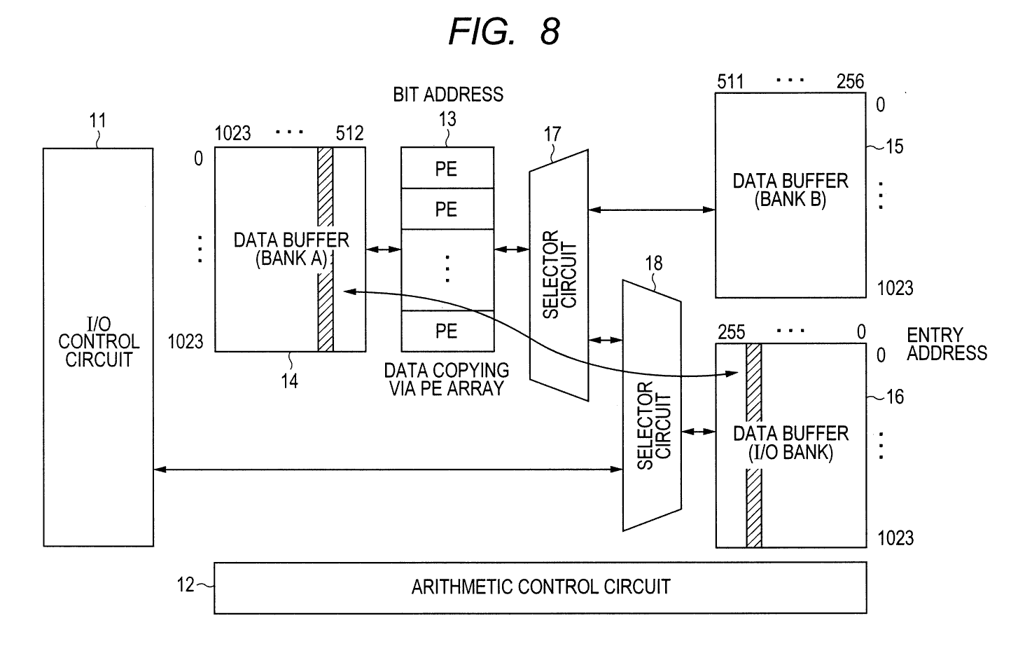

FIG. 8 is a diagram for describing data copying between banks. Referring to FIG. 8, the selector circuits 17 and 18 are coupled to the PEs 13 and I/O bank 16, respectively, and the PEs 13 copy data stored in the I/O bank 16 to bank A 14 or bank B 15 for subsequent processing.

As shown in FIG. 8, data copying performed by the PEs 13 enables data transferred from the external memory 104 to the I/O bank 16 to be transferred to bank A 14 or bank B 15 or data obtained as a result of processing and stored in bank A 14 or bank B 15 to be transferred to the I/O bank 16.

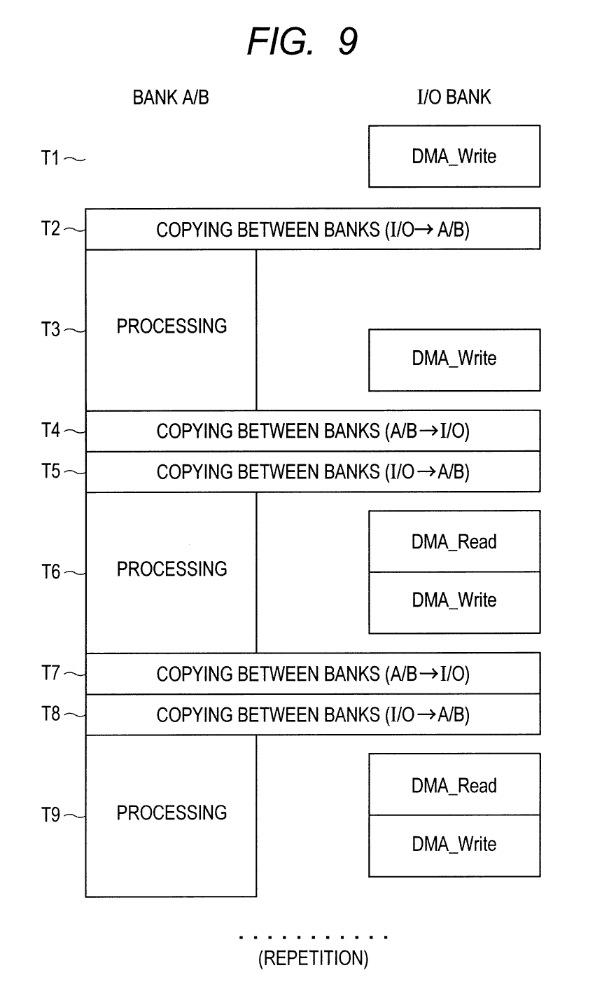

FIG. 9 is a diagram for describing an operating sequence, including parallel processing described with reference to FIG. 7 and data copying between banks described with reference to FIG. 8, of the parallel processing module according to the present embodiment of the invention. First, at T1, the operation control circuit 12 couples, by switching the selector circuit 18, the I/O control circuit 11 with the I/O bank 16 and has data for use in subsequent processing DMA-transferred from the external memory 104 to the I/O bank 16.

After making sure that the PEs 13 are not engaged in any processing and that no DMA-transfer is being performed, the operation control circuit 12 couples at T2, by switching the selector circuits 17 and 18, the PEs 13 with the I/O bank 16, and causes, by controlling the PEs 13, the data DMA-transferred to the I/O bank 16 to be copied from the I/O bank 16 to bank A 14 or bank B 15.

At 13, the operation control circuit 12 couples, by switching the selector circuit 17, the PEs 13 with bank B 15, and causes, by controlling the PEs 13, processing to be performed by the PEs 13 using bank A 14 and bank B 15. Concurrently with this processing, the operation control circuit 12 couples, by switching the selector circuit 18, the I/O control circuit 11 with the I/O bank 16, and has data required for subsequent processing DMA-transferred from the external memory 104 to the I/O bank 16.

After making sure that the PEs 13 are not engaged in any processing and that no DMA-transfer is being performed, the operation control circuit 12 couples at T4, by switching the selector circuits 17 and 18, the PEs 13 with the I/O bank 16, and causes, by controlling the PEs 13, the data obtained as a result of processing and stored in bank A 14 or bank B 15 to be copied to the I/O bank 16.

At T5, the operation control circuit 12 copies data already DMA-transferred, for subsequent processing, to the I/O bank 16 to bank A 14 or bank B 15.

At T6, the operation control circuit 12 couples, by switching the selector circuit 17, the PEs 13 with bank B 15, and causes, by controlling the PEs 13, processing to be performed by the PEs 13 using bank A 14 and bank B 15. Concurrently with this processing, the operation control circuit 12 couples, by switching the selector circuit 18, the I/O control circuit 11 with the I/O bank 16, and has the data obtained as a result of processing DMA-transferred from the I/O bank 16 to the external memory 104 while also having data required for subsequent processing DMA-transferred from the external memory 104 to the I/O bank 16.

After making sure that the PEs 13 are not engaged in any processing and that no DMA-transfer is being performed, the operation control circuit 12 couples at T7, by switching the selector circuits 17 and 18, the PEs 13 with the I/O bank 16, and causes, by controlling the PEs 13, the data obtained as a result of processing and stored in bank A 14 or bank B 15 to be copied to the I/O bank 16.

At T8, the operation control circuit 12 copies data already DMA-transferred, for subsequent processing, to the I/O bank 16 to bank A 14 or bank B 15.

At T9, the operation control circuit 12 couples, by switching the selector circuit 17, the PEs 13 with bank B 15, and causes, by controlling the PEs 13, processing to be performed by the PEs 13 using bank A 14 and bank B 15. Concurrently with this processing, the operation control circuit 12 couples, by switching the selector circuit 18, the I/O control circuit 11 with the I/O bank 16, and has the data obtained as a result of processing DMA-transferred from the I/O bank 16 to the external memory 104 while also having data required for subsequent processing DMA-transferred from the external memory 104 to the I/O bank 16.

The processing operations performed at T4 through T9 are repeated as many times as required for image data processing.

When the parallel processing module is operated as described above, data copying between the I/O bank 16 and bank A 14 or bank B15 is performed by the PEs 13 under the control of the operation control circuit 12. Namely, the operations at T2, T4, T5, T7, and T8 are performed by operation programs. The data copying between banks takes a number of cycles.

In cases where a massively parallel configuration including a very large number of processing elements (PEs 13) is used to collectively process a large volume of data at a high speed, the processing bus between banks has a much larger width than the system bus, so that data copying from the I/O bank to bank A 14 or bank B 15 can be performed taking an ignorably small number of cycles compared to the number of cycles required for processing performed using bank A 14 and bank B 15. Hence, it can be said that, when a massively parallel configuration including a very large number of processing elements (PEs 13) is used, the effect of the present invention to increase the processing speed is very large.

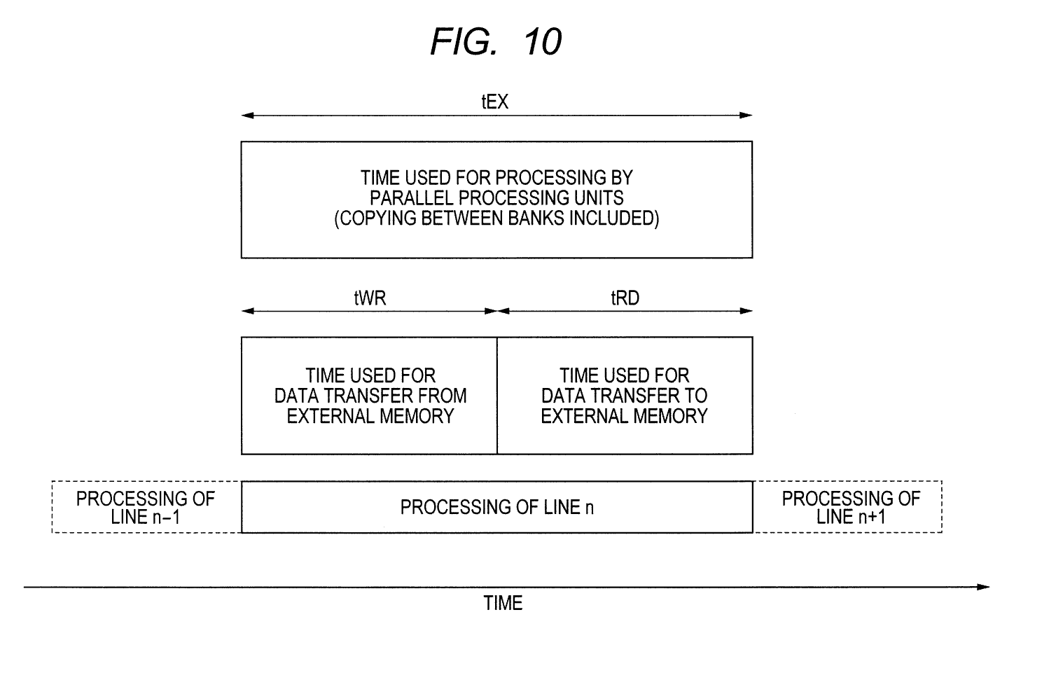

FIG. 10 is a diagram for describing the processing time used to process a one-line portion of image data using the data processing device according to the present embodiment of the invention. As shown in FIG. 10, in the image data processing for the nth line, a data transfer from the external memory 104 and a data transfer to the external memory 104 are performed in series while data processing by the parallel processing elements (PEs 13) is performed concurrently with the data transfers. The time taken by the nth line processing is, therefore, the sum of tWR used for the data transfer from the external memory 104 and tRD used for the data transfer to the external memory 104 or equals tEX used for processing by the parallel processing elements. Thus, processing can be performed in a shorter time. The processing time used by the parallel processing elements includes the time used for data copying between banks.

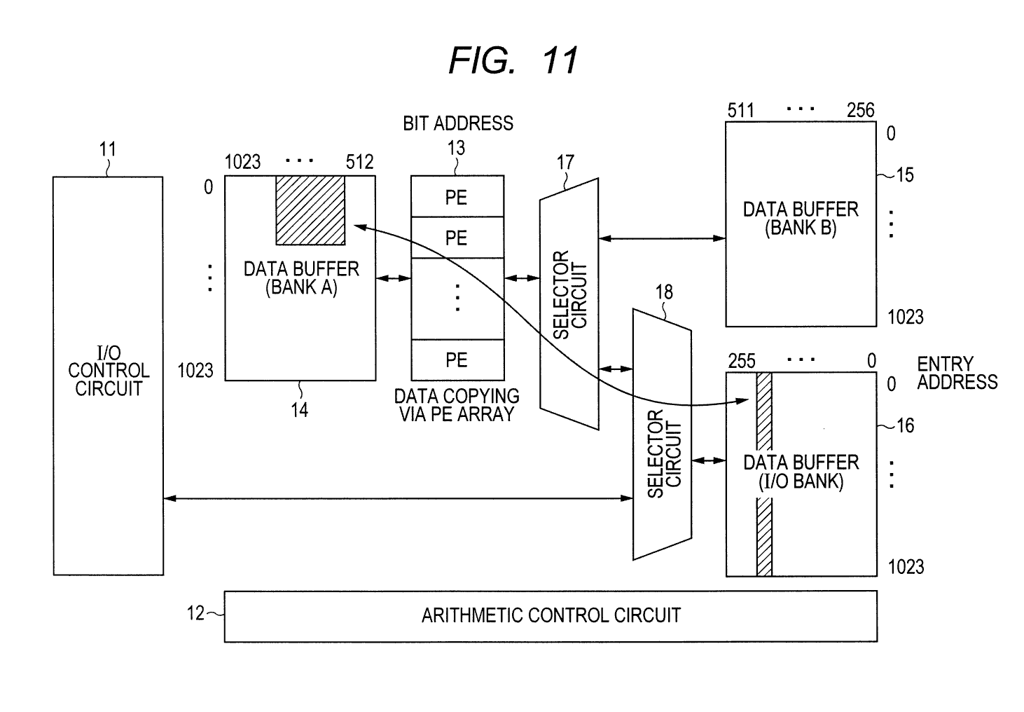

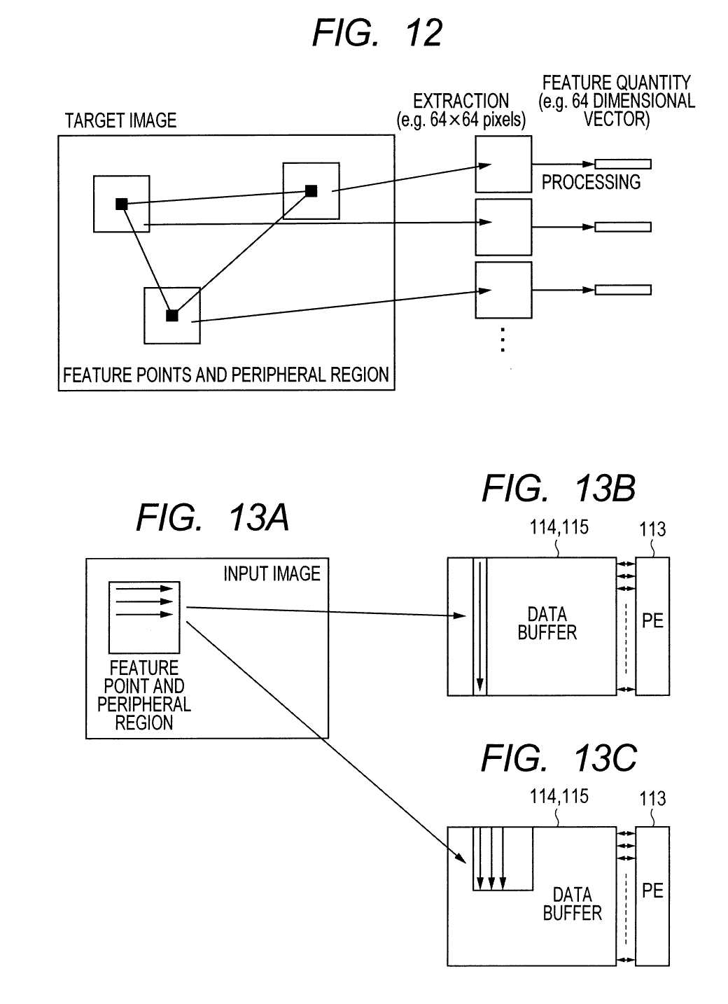

FIG. 11 is a diagram for describing the re-arrangement of region-of-interest (ROI) data performed by data copying between banks. FIG. 12 is a diagram showing an example of ROI data processing. Referring to FIG. 12, feature point and peripheral region image data is extracted, for example, in units of 64-by-64 pixels and the extracted pixel data is processed to output feature amounts as 64 dimensional vectors. If, at this time, the extracted image data is transferred to the data buffer 114 or 115 included in the parallel processing module, the data is linearly aligned in the data buffer 114 or 115.

FIGS. 13(a) to 13(c) show different manners in which image data at a feature point and peripheral region thereof is extracted and stored in the data buffer 114 or 115. FIG. 13(a) shows a feature point and peripheral region thereof of the input image stored in the external memory 104.

FIG. 13(b) shows the feature point and peripheral region thereof extracted and DMA-transferred to the data buffer 114 or 115. As shown in FIG. 13(b), the image data is linearly aligned in the data buffer 114 or 115.

FIG. 13(c) shows the extracted image data two dimensionally stored in the data buffer 114 or 115. As shown in FIG. 13(c), an arrangement for two dimensionally storing image data in the data buffer 114 or 115 is required.

As described with reference to FIGS. 13(a) to 13(c), DMA-transferring feature point and peripheral region image data from the external memory 104 to the I/O bank 16 causes the image data to be linearly aligned in the I/O bank 16. The operation control circuit 12 controls the PEs 13 to have the image data linearly aligned in the I/O bank 16 copied to and two-dimensionally stored in bank A 14.

When, for example, the extracted image data comprises 64 by 64 pixels, the extracted image data can be processed using 64 specific PEs 13, so that the other PEs 13 can be used to concurrently process other feature point and peripheral region image data also extracted.

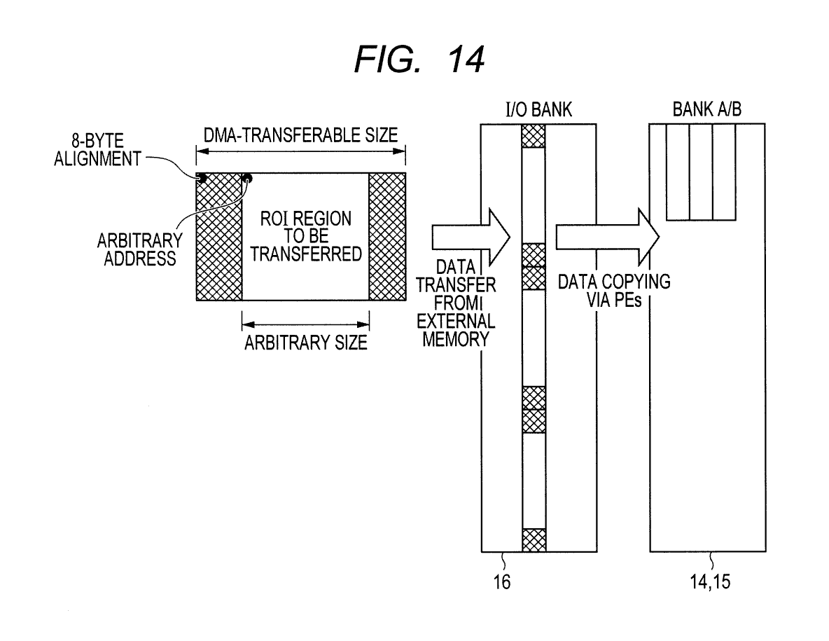

FIG. 14 is a diagram for describing data alignment resulting from data copying between banks. The size of data which can be DMA-transferred by data copying between banks is defined by the width of the system bus. Namely, when the system bus has a width of 64 bits, data can be DMA-transferred only in 64-bit units. It is not possible to DMA-transfer image data in arbitrary sizes.

As shown in FIG. 14, when the ROI region is smaller than 64 bits, the 64-bit image data including the ROI region and other unnecessary regions, shaded in FIG. 14, is DMA-transferred to the I/O bank to be linearly aligned there. The operation control circuit 12 controls the PEs 13 to have, out of the linearly aligned image data in the I/O bank 16, only the image data corresponding to the ROI region to be copied to and two-dimensionally aligned in bank A 14 or bank B 15.

When image data is two-dimensionally aligned in bank A 14 (or bank B 15), the image data can be processed, in the two-dimensionally aligned state, by the parallel processing elements, so that image data processing involving mutually adjacent pixels can be performed at high speed. It is possible to concurrently process the image data including both the ROI region and unnecessary regions as shown in FIG. 14, but processing the image data aligned in bank A 14 or bank B 15 as shown in FIG. 14 allows the unused portion of the bank to be also made use of. In that way, the parallel processing elements can be made the most of to achieve higher processing efficiency.

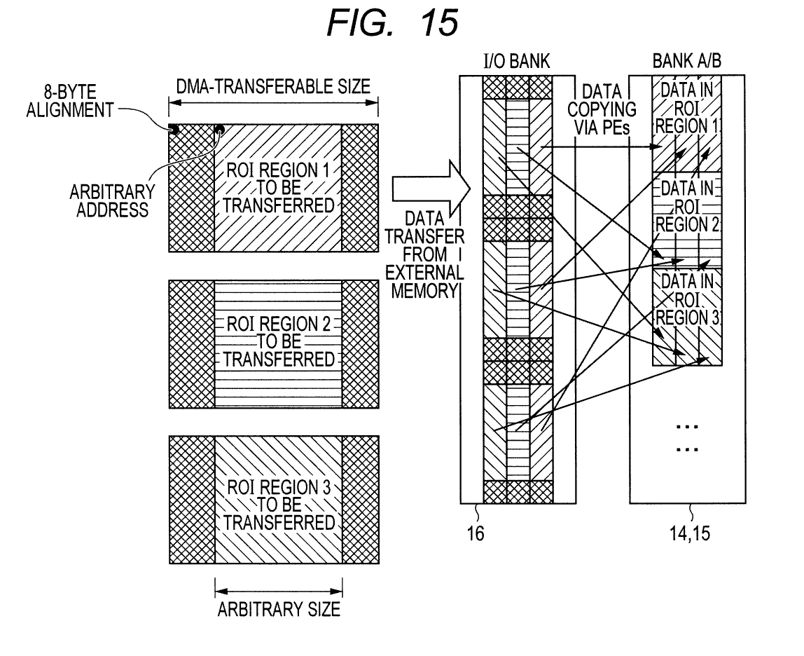

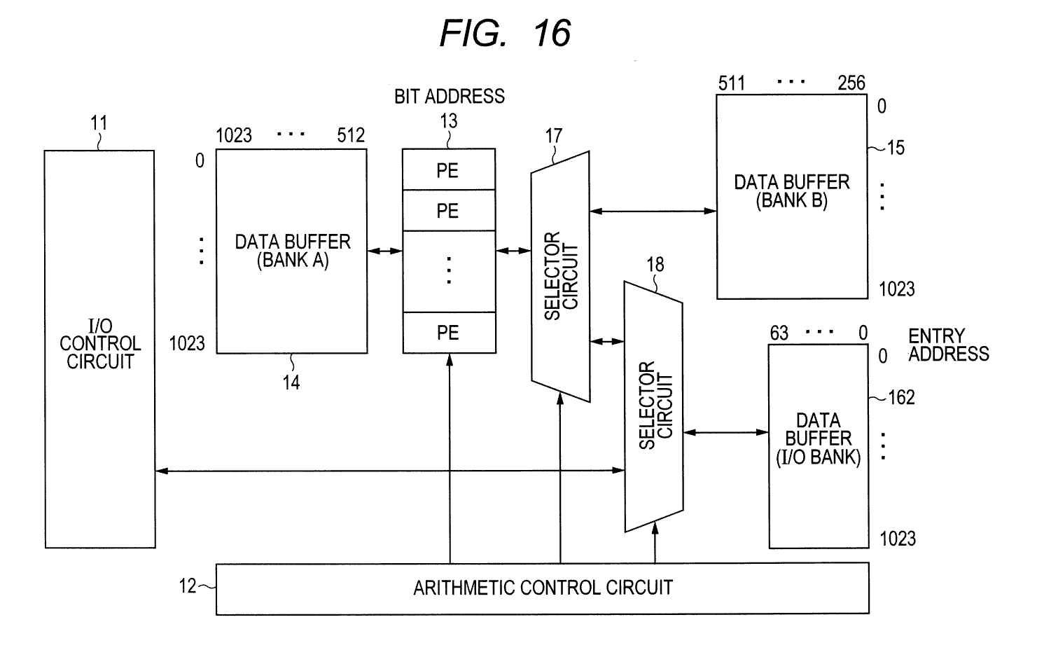

FIG. 15 is a diagram for describing efficient data alignment which can be achieved by data copying between banks. To be concrete, transferring plural ROI regions, as shown in FIG. 15, to the I/O bank 16 and copying the ROI regions to bank A 14 or bank B 15 while aligning them two-dimensionally makes it possible to concurrently process the copied ROI region image data efficiently.

As described above, according to the data processing device of the present embodiment, only the I/O bank 16 is allowed to exchange data with the external memory 104, and data is transferred between the I/O bank 16 and the external memory 104 concurrently with the data processing performed by the PEs 13 using bank A 14 or bank B 15. This increases the speed of image data processing performed using parallel processing elements.

Furthermore, data transfer between the I/O bank 16 and bank A 14 or bank B 15 is also performed using the PEs 13, so that data can be transferred faster between banks, too.

Still furthermore, image data transferred to the I/O bank 16 is processed, after being copied from the I/O bank to bank A 14 or bank B 15, using bank A 14 or bank B 15. Thus, an arbitrary size of ROI data can be two-dimensionally aligned in a data buffer, so that the parallel processing elements can efficiently perform image processing.

Even in cases where unnecessary image data is aligned in the I/O bank 16 due to limitations to DMA transfer, it is possible to copy the required ROI data only from the I/O bank 16 to bank A 14 or bank B 15 using the PEs 13. This allows the parallel processing elements to efficiently perform image processing.

### Example Modification

FIG. 16 is a diagram showing an example configuration of the parallel processing module of a data processing device according to a modification of the above embodiment of the present invention. In the following description, the same components as those of the data processing device shown in FIG. 8 will be denoted by the same reference numerals as those used in FIG. 8 and detailed description of such components will not be repeated.

Referring to FIG. 16, the parallel processing module includes an input/output control circuit 11, an operation control circuit 12, PEs 13 corresponding to the number of entries, data buffers 14, 15, and 162, and selector circuits 17 and 18. The overall configuration of the data processing device is similar to that shown in FIG. 1.

In image data processing, there are many cases in which differences between adjoining frames are calculated and neighboring image data or once processed image data is made use of for subsequent processing, so that it is not necessary to transfer the entire image data to be processed from the external memory 104 for every processing operation. Image data to be used in plural processing operations can be retained in bank A 14 or bank B 15.

When, for example, differences between adjoining frames are to be calculated, data to be transferred during plural processing operations is, in many cases, limited to newly required image data and image data produced as a result of processing, so that the I/O bank 162 for use in data transfer can be made relatively small in capacity compared to bank A 14 and bank B 15.

As described above, according to the modification of the foregoing embodiment of the present invention, the I/O bank 162 can be made small in capacity relative to bank A 14 or bank B 15, so that the data processing device can be formed on a smaller chip.

### Example Application

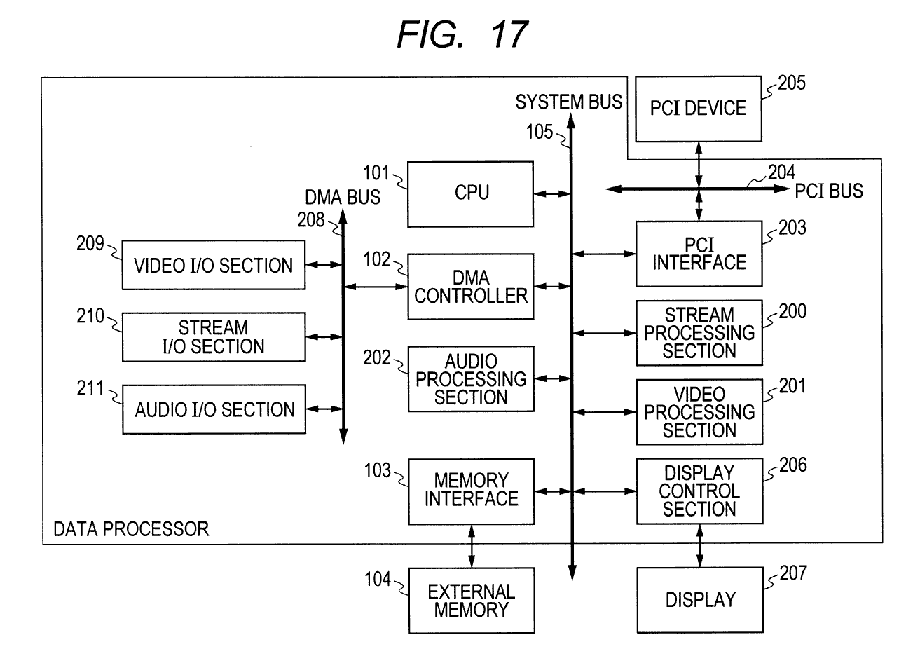

FIG. 17 shows an example system including the data processing device of the present invention. In the following description, the same components as those of the data processing device shown in FIG. 1 will be denoted by the same reference numerals as those used in FIG. 1 and detailed description of such components will not be repeated.

Referring to FIG. 17, a stream processing section 200 performs stream processing which is a part of video codec processing based on, for example, the Moving Picture Experts Group (MPEG) standard. A video processing section 201 performs, in conjunction with the stream processing section 200, encoding/decoding as video codec processing. An audio processing section 202 performs encoding/decoding as audio codec processing.

A PCI interface 203 couples the system bus 105 with a PCI bus 204, which is a standard bus. Various PCI devices 205, for example, a hard disk drive, are coupled to the PCI bus 204.

A display control section 206 is coupled to a display 207 to control image display on the display 207.

Various I/O devices are coupled to the DMA controller 102 via the DMA bus 208. The I/O devices include, for example, an image I/O section 209 for inputting/outputting, for example, an image shot by a camera, a stream. I/O section 210 for inputting/outputting an image stream, and an audio I/O section 211 for inputting/outputting audio data.

The parallel processing module according to the present invention is installed, for example, in the stream processing section 200 and performs image processing. Examples of this type of systems having video and audio input/output and performing video and audio processing include, for example, mobile phones and cameras.

The above embodiment of the invention should be considered in all respects as illustrative and not restrictive. The scope of the invention is defined by the appended claims, rather than the foregoing description, and the invention is intended to cover all alternatives and modifications coming within the meaning and range of equivalency of the claims.

What is claimed is:

1. A data processing device including a processor and a parallel processing module coupled to each other via a system bus, the parallel processing module performing processing according to a request from the processor,
wherein the parallel processing module comprises:
a plurality of processing elements;
a first bank and a second bank provided to correspond to the processing elements and used to store data to be used when the processing elements perform processing;
a third bank provided to correspond to the processing elements and used to transfer data to and from an external memory via the system bus;
a first selection unit for selectively coupling the second bank or the third bank to the processing elements; and
a second selection unit for selectively coupling the external memory or the processing elements to the third bank.

2. The data processing device according to claim 1, further including a control unit,
wherein, by switching the first selection unit and the second selection unit, the control unit allows the second bank to be coupled to the processing elements and makes the processing elements perform processing, and concurrently with the processing, the control unit allows the external memory to be coupled to the third bank to perform data transfer, thereafter, by switching the second selection unit, the control unit allows the third bank to be coupled to the processing elements, and causes data stored in the third bank for being processed to be copied to the first bank or the second bank.

3. The data processing device according to claim 2, wherein the control unit copies data linearly aligned in the third bank for being processed to the first bank or the second bank such that the copied data is two-dimensionally aligned in the first bank or the second bank.

4. The data processing device according to claim 3, wherein the control unit copies data linearly aligned in the third bank for being processed to the first bank or the second bank without including unnecessary data such that the copied data is two-dimensionally aligned in the first bank or the second bank.

5. The data processing device according to one of claims 1 to 4, wherein the parallel processing module has a processing bus larger in width than the system bus and can copy data from the third bank to the first bank or the second bank faster than data is copied from the external memory to the third bank.

6. The data processing device according to one of claims 1 to 5, wherein the third bank is smaller in capacity than each of the first bank and the second bank.

7. The data processing device according to claim 1, further including an input/output section for inputting and outputting data from and to outside,
wherein the external memory stores data inputted to the input/output section and transfers the stored input data to the third bank responding to a request from the processor.

8. A parallel processing unit, comprising;
a plurality of processing elements;
a first bank and a second bank provided to correspond to the processing elements and used to store data to be used when the processing elements perform processing;
a third bank provided to correspond to the processing elements and used to transfer data to and from an external memory;
a first selection unit for selectively coupling the second bank or the third bank to the processing elements; and
a second selection unit for selectively coupling the external memory or the processing elements to the third bank.

9. The parallel processing unit according to claim 8, further comprising a control unit,
wherein, by switching the first selection unit and the second selection unit, the control unit allows the second bank to be coupled to the processing elements and makes the processing elements perform processing, and concurrently with the processing, the control unit allows the external memory to be coupled to the third bank to perform data transfer, thereafter, by switching the second selection unit, the control unit allows the third bank to be coupled to the processing elements, and causes data stored in the third bank for being processed to be copied to the first bank or the second bank.
